(19) United States
(12) Patent Application Publication
(10) Pub. No.: US 2017/0241379 A1
(43) Pub. Date: Aug. 24, 2017

(54) High Velocity Vapor Injector for Liquid Fuel Based Engine

(71) Applicant: Donald Joseph Stoddard, Tooele, UT (US)

(72) Inventor: Donald Joseph Stoddard, Tooele, UT (US)

(21) Appl. No.: 15/203,741

(22) Filed: Jul. 6, 2016

Related U.S. Application Data
(60) Provisional application No. 62/298,266, filed on Feb. 22, 2016.

(51) Int. Cl. F02M 31/18; F02M 63/00; F02M 67/02; F02M 51/06; F02M 25/038; F02B 19/02

(52) U.S. Cl. CPC F02M 31/18; F02M 25/038; F02B 19/02; F02M 67/02; F02M 51/0689; F02M 63/0035

(57) ABSTRACT

The present invention provides systems, methods and apparatus to overcome limitations of liquid fuel engine combustion. Liquid fuel is mixed with superheated water which vaporizes, mixes with air and ignites within the injector nozzle. The injector nozzles then accelerate the mixture into the engine combustion chamber where unburned fuel vapor mixes and burns. Combustion begins the instant of injection and increases uniformly. Combustion pressure builds progressively. Combustion of fuel vapor is more ideal, and better controlled. As part of the system and apparatus, the present disclosure also includes a low-cost high-speed solenoid valve which produces shorter injection pulses. It also includes a high-speed, high-air-volume solenoid fuel valve. In addition, the present invention and its disclosure create tools to develop and optimize this new method of fuel vapor injection.

### CROSS-REFERENCE TO RELATED APPLICATIONS

This application is filed concurrently with Application for Letters of Patent for Liquid Fuel Based Engine System Using High Velocity Fuel Vapor Injectors, application Ser. No. 15/203,769, filed on Jul. 6, 2016. This application claims priority to the following Provisional Applications: Ser. No. 62/298,266 filed Feb. 2, 2016. The following commonly owned patent is hereby incorporated by reference for all purposes:

U.S. patent application Ser. No. 14/670,318 filed Mar. 26, 2015, entitled “Momentum Driven Fuel Injection of Steam and Fuel Vapor for Compression Ignition Engines” by Donald Joseph Stoddard.

### FEDERALLY SPONSORED RESEARCH OR DEVELOPMENT

None

### BACKGROUND OF INVENTION

Field of the Invention

Liquid fueled engines are used in a wide range of heat engines. The present invention changes the combustion process, reduces emissions and improves fuel efficiency.

Description of Related Art

The diesel engine combustion process provides an understanding of combustion limitations of liquid fuel and the potential of the present invention. During the past decades, researchers have improved diesel engine reliability and emissions. However, fuel efficiency improvements are disappointing, and the primary limitations of diesel fuel characteristics have not been solved. Diesel fuel vaporizes poorly, but autoignites easily. To make matters worse, emissions requirements are increasingly difficult while, for economics, there is a great need to improve efficiency.

The following explains why liquid fuel injection inherently produces an uncontrollable combustion process. A droplet of liquid fuel the diameter of a human hair contains 3e¹⁵ molecules (3 followed by 15 zeros) which must mix into 360e¹⁵ air molecules in a volume one thousand times larger. Expanding and mixing on this numerically large scale into a larger volume creates chaos in which molecular environments change radically and continuously. In this case, chaos produces almost every unwanted combustion product possible. Local combustion temperatures and chemical reactions vary throughout the combustion process changing from point to point and changing over time. There are over 50 different unwanted products including nitrous oxides, carbon monoxide, ammonia, soot, and unburned hydrocarbons that are produced during combustion of liquid fuel droplets. Presently, diesel exhaust must be treated to protect the environment. Ideally, combustion would produce only water and carbon dioxide.

Current diesel combustion research is pursuing Low Temperature Combustion (LTC) to improve fuel vaporization. Typically, exhaust gas is re-circulated into the intake air. Combustion begins with Low Temperature Heat Release (LTHR) which slowly releases enough heat to initiate main combustion. The delay before main combustion improves vaporization. However, it is difficult to control LTHR and even more difficult to do so for both heavy and light loads.

LTC can also be used to improve fuel efficiency. Less heat is lost (wasted) in the coolant if main combustion temperature is reduced. Theoretical calculations show LTC can improve fuel efficiency by 20% as noted by the Department of Energy. That is a theoretical limit which for various reasons cannot be achieved. However, it shows the potential value of a system that reduces the temperature of main combustion.

Injector valve speed needs to increase. Considerable effort has gone into piezo-electric injectors and magneto-constrictive material injectors. These solutions closely control injection rates at high speeds, even adjusting fuel flow rates during injection. These solutions are faster than necessary and expensive. It would therefore be advantageous to design a low-cost high-speed solenoid valve.

One of the limitations of solenoid injector speed is that an electro magnet pulls a needle from the needle valve seat into the open position. Due to the gap between the needle and the electro-magnet, force on the needle is initially low and increases as the needle body moves closer to the electro-magnet. Low force at the beginning results in lower acceleration and slower injector speed.

The combustion process of prior art has several drawbacks. Injected liquid fuel droplets create their own radically changing combustion environments. These chaotic conditions have many undesirable effects. 1) Changing fuel vapor concentrations around each liquid fuel droplet produce many unwanted chemical reactions that add to pollution. 2) Early auto-ignition adds to pollution. Auto-ignition initiates combustion before fuel becomes mixed. As a result, high local concentrations of fuel vapor produce carbon emissions as soot or smoke as well as other unseen emissions. 3) Abrupt auto-ignition stresses engine components and often leads to engine component failure. As liquid fuel starts evaporating and mixing, ignition conditions are met for the fuel that has vaporized to ignite. The quantity of fuel ignited all at once creates a small explosion. 4) Due to limited combustion control, liquid fuel injection has not progressed to produce marketable high efficiency LTC engines. 5) Liquid fuel injection in some cases produces burning liquid pools of fuel on piston crowns or washes the combustion chamber walls with liquid fuel. These extreme conditions are indicative of just how poorly diesel liquid fuel vaporizes during combustion. 6) Heavy loads increase particulate emissions, often seen as heavy smoke from the engine exhaust. Other pollutants increase as well, but are not as easily observed.

It would be advantageous, therefore, to devise systems, methods and apparatus to improve the above limitations of liquid fuel engine combustion.

### BRIEF DESCRIPTION OF THE PRESENT INVENTION

Fuel is injected as a vapor at High velocities in the following process. Water is said to be superheated when it is heated above its boiling temperature under pressure that prevents vaporization. Heat stored in superheating causes water to vaporize when pressure is released. Liquid fuel is mixed into superheated water which vaporizes itself and vaporizes the liquid fuel. Air is mixed into the expanding fuel vapor and steam mixture which ignites due to the temperature of the compressed air. This burning mixture enters nozzles where it expands and accelerates entering the engine combustion chamber at high velocities. The injector nozzle is a well understood design used in rocket engines and turbines. Part of the fuel vapor burns within the injector nozzle, but most of the fuel vapor burns in the engine combustion chamber.

The preferred embodiment of the present invention makes Low Temperature Combustion feasible. When fuel is well distributed as a vapor, the combustion process is uniform regardless of how much fuel is injected. That allows the engine to run lean. When combustion is complete, extra air remains un-combusted. The extra air absorbs heat and reduces combustion temperature. However, due to conservation of energy, pressure is not reduced in the combustion process. The excess air adds as much pressure as is lost by the rest of the combustion chamber gases. Control of the combustion process makes LTC operation for the whole combustion process possible.

The preferred embodiment of the present invention includes a high-speed push-pull electrical solenoid circuit. The shuttle or piston is the moving part of the solenoid. There are windings that control magnetic fields in the shuttle. The shuttle is placed between two permanent magnets which attract on one end and repel on the other. Force is greatest when the distance between the shuttle and either stator is smallest. At rest, the shuttle is against one shuttle and spaced away from the other. When current in the windings reverse, fields reverse in the shuttle. The magnetic force in the narrow repelling gap is at its maximum and falls as the gap increases between repelling magnet and shuttle. The attracting force of the other magnet increases as the shuttle approaches. As a result the total force of repulsion and attraction is more nearly constant and can even increase at the midpoint. As a result the shuttle is strongly accelerated throughout its movement between positions. Notice that a single stator solenoid has only attractive force and starts with the shuttle distant from the stator.

The preferred embodiment of the present invention uses more valves than a normal fuel injector, manufacturing costs must be minimized. Per unit valve cost is reduced by manufacture of a large number of similar valves. In addition, a simpler design reduces manufacturing cost by separately fabricating valves and inserting them into a less complex injector body.

The preferred embodiment of the present invention includes an air mass injector to inject enough air into the injector. Air is compressed and then injected by a superheated water pressure ram into the Nozzles where it mixes with fuel vapor and ignites due to compressed air temperature.

The preferred embodiment of the present invention has several operating modes. In the high power mode, the controller prevents injection of more fuel than is combusted. In a maximum efficiency mode, the operator chooses an engine output such as road speed. The controller switches to high efficiency LTC combustion mode while maintaining engine output. In another mode, the controller provides a display to help the operator improve fuel efficiency while meeting other objectives.

In the preferred embodiment of the present invention the controller controls combustion temperature by sensing exhaust free-oxygen concentration. Higher exhaust free-oxygen concentration indicates excess air and lower combustion temperature. Under maximum power operation, the controller prevents excess fuel injection by preventing zero oxygen concentration.

In the preferred embodiment of the present invention, the water super-heater uses heat from the engine exhaust and from fuel combustion within the heater combustion chamber. During startup, or to supplement exhaust heat, the controller injects and ignites liquid fuel in the heater combustion chamber. As soon as water becomes superheated, fuel vapor and steam are injected into the engine combustion chamber at subsonic velocity. The engine idles until pressure builds in the air supply. When air pressure is sufficient, compressed air is injected into the fuel vapor in the injector nozzles. Fuel ignites due to temperature of the compressed air. High velocity fuel vapor injection begins and engine operation becomes normal.

The preferred embodiment of the present invention includes a latching, high-volume, fast-acting, solenoid air valve that fits within the injector. This air valve delivers a larger volume than the other valves. In addition, the latching mechanism minimizes the forces for opening and closing which reduces the size of the electrical solenoid.

### SUMMARY OF PRESENT INVENTION

Whereas liquid fuel injection of prior art creates a chaotic combustion process, the present invention creates a more ideal combustion environment. There are many advantages. 1) The more ideal combustion environment reduces the many unwanted chemical pollutants produced by liquid fuel injection. 2) Smoke and other pollutants are reduced by eliminating local fuel concentrations surrounding fuel droplets. 3) Shock to engine components is avoided by progressively increasing combustion pressure. Combustion begins the instant fuel vapor is injected and pressure builds as more fuel vapor arrives. In contrast, when liquid fuel is injected, liquid droplets vaporize and mix until ignition conditions are met. Then the vaporized fuel explodes. Stresses of abrupt auto-ignition frequently cause engine component failures. 4) Highly efficient LTC engine design becomes possible due to well controlled combustion of the present invention. LTC research with liquid fuel injection has not progressed to this point and shows no evidence of doing so. 5) There is no liquid fuel to impinge on cylinder walls or collect as burning pools on piston crowns. 6) Combustion is well controlled for all power levels. In contrast, liquid fuel injection typically produces more smoke and un-seen emissions when power is increased.

The present invention therefore provides systems, methods and apparatus to overcome the limitations of liquid fuel engine combustion. It also includes a low-cost high-speed solenoid valve which produces shorter injection pulses. It also includes a high-speed, high-air-volume solenoid fuel valve. In addition, the present invention and its disclosure create tools to develop and optimize this new method of fuel vapor injection.

### BRIEF DESCRIPTION OF DRAWINGS

FIG. 1 is a Block Diagram of a High Velocity Fuel Vapor Injector.

FIG. 2A depicts a Front View of an Injector Assembly. FIG. 2B depicts a Rear View of an Injector Assembly.

FIG. 3A depicts an End View of a High Velocity Fuel Vapor Injector Assembly. FIG. 3B depicts a Front View of a High Velocity Fuel Vapor Injector Assembly. FIG. 3C depicts a Side View of a High Velocity Fuel Vapor Injector Assembly.

FIG. 4 depicts a cross-section illustrating Injector Nozzle Details.

FIG. 5 depicts a Block Diagram for the Preferred Embodiment of a Liquid Fuel Based Engine System Using High Velocity Fuel Vapor Injectors.

FIG. 6 depicts a Block Diagram of an Air Mass Delivery System.

FIG. 7A depicts a Rear View of an Injector Assembly illustrating an Air Mass Delivery System. FIG. 7B depicts an End View of an Injector Assembly illustrating an Air Mass Delivery System.

FIG. 8A depicts a High-Speed Push-Pull Solenoid Valve Assembly Using Permanent Magnet Stators. FIG. 8B depicts a High-Speed Push-Pull Solenoid Valve Assembly Using Electro-Magnet Stators.

FIG. 9 depicts an Exhausted Heated Superheated Water Heater.

FIG. 10 depicts a Combustion Temperature Control System.

FIG. 11A depicts a Latching, High-Volume, Fast-Acting, Solenoid Air Valve in its On State. FIG. 11B depicts a Latching, High-Volume, Fast-Acting, Solenoid Air Valve in its Off State.

FIG. 12A depicts a Poppet Valve and Valve Guide. FIG. 12B depicts a Poppet Valve Guide.

FIG. 12C depicts the Latching Mechanism for a Poppet Valve in its on state. FIG. 12D depicts the Latching Mechanism for a Poppet Valve in its off or closed state.

### DETAILED DESCRIPTION OF SPECIFIC EMBODIMENTS

A better understanding of the present invention can be obtained when the following detailed description of the preferred embodiment is considered in conjunction with the drawings, in which:

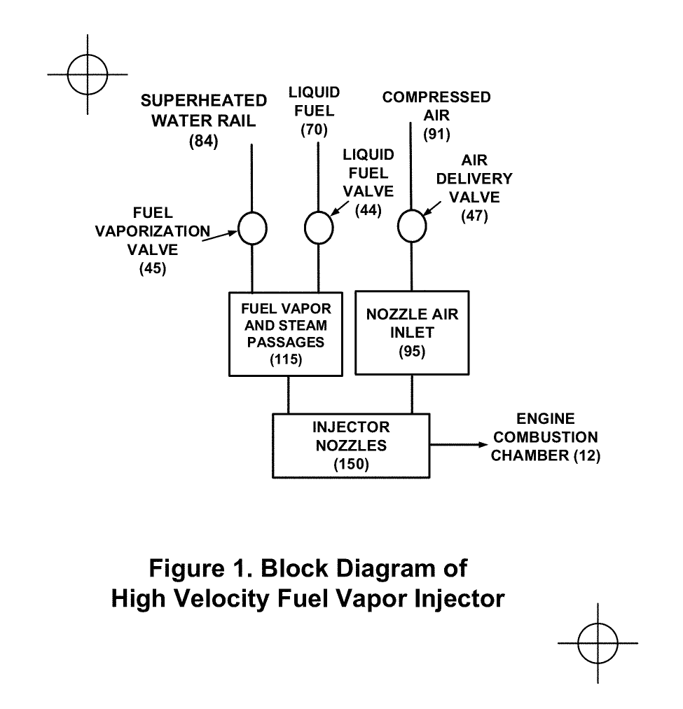

FIG. 1 depicts a Block Diagram of the preferred embodiment of a High Velocity Fuel Vapor Injector. The Fuel Vaporization Valve (45) admits Superheated Water (80) (not shown) from the Superheated Water Rail (84) into the Fuel Vapor and Steam Passages (115). The Liquid Fuel Valve (44) admits Liquid Fuel (70) into the Fuel Vapor and Steam Passages (115). The mixture of Liquid Fuel (70) and Superheated Water (80) (not shown) in the Fuel Vapor and Steam Passages (115) vaporize and enter the Injector Nozzle Inlet (151) (not shown). The Air Delivery Valve (47) admits Compressed Air (91) through the Air Transition Passages (140) into the Injector Nozzle Inlet (151) (not shown). The Fuel Vapor (74) (not shown) and Steam (83) (not shown) mix with Compressed Air (91) (not shown) and ignite in the Injector Nozzle Inlet (151) (not shown). The Nozzles (150) expand and accelerate the burning mixture into the Engine Combustion Chamber (12). Part of the Fuel Vapor (74) (not shown) burns within the Nozzles (150) and the remaining Fuel Vapor (74) (not shown) mixes with Air (75) in the Engine Combustion Chamber (12) and burns.

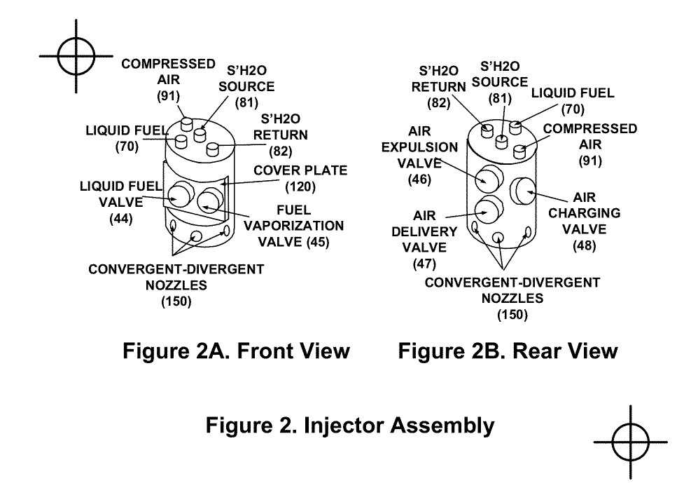

FIG. 2A depicts a front view of an Injector Assembly. At the top External Ports (42) (not indicated) are shown for Liquid Fuel (70), Compressed Air (91), Superheated Water (S′H2O) Source (81) and Superheated Water (S′H2O) Return (82). The Liquid Fuel Valve (44), the Fuel Vaporization Valve (45) and the Cover Plate (120) are shown in the middle. Injector Nozzles (150) appear at the bottom. FIG. 2B depicts a rear view of an Injector Assembly. At the top External Ports (42) (not indicated) are shown for Liquid Fuel (70), Compressed Air (91), Superheated Water (S′H2O) Source (81) and Superheated Water (S′H2O) Return (82). The Air Charging Valve (48), the Air Expulsion Valve (46), and the Air Delivery Valve (47) are shown in the middle. Injector Nozzles (150) appear at the bottom.

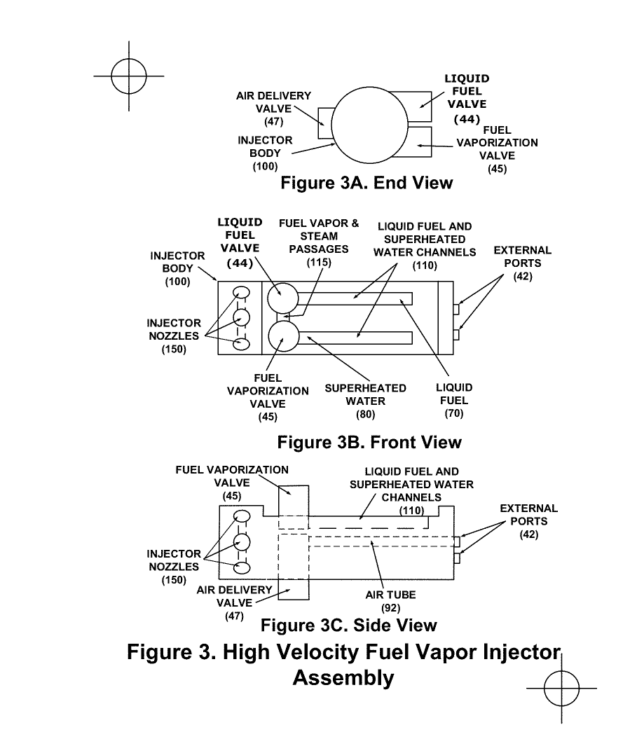

FIG. 3A, End View of a High Velocity Fuel Vapor Injector Assembly depicts the Injector Body (100), the Air Delivery Valve (47), the Liquid Fuel Valve (44), and the Fuel Vaporization Valve (45). FIG. 3B, Front View of a High Velocity Fuel Vapor Injector Assembly depicts the Nozzles (150) in the Injector Body (100). The Liquid Fuel Valve (44) and the Fuel Vaporization Valve (45) are installed between the Fuel Vapor and Steam Passages (115) and the Liquid Fuel and Superheated Water Channels (110). The Fuel Vapor and Steam Passages (115) connect (connection not shown) to the Nozzles (150). Liquid Fuel (70) and Superheated Water (80) are indicated in their channels. External Ports (42) are indicated at the right. FIG. 3C, Side View of a High Velocity Fuel Vapor Injector Assembly depicts the Nozzles (150) in the Injector Body (100), the Air Delivery Valve (47) at the bottom extending into the Air Tube (92) (dashed lines) and into the Fuel Vapor and Steam Passages (115) (not shown). The Fuel Vaporization Valve (45) extends into the Liquid Fuel and Superheated Water Channels (110) (dashed lines) and into the Fuel Vapor and Steam Passages (115) (not shown). The External Ports (42) are shown at right with dashed lines to the Air Delivery Valve (47).

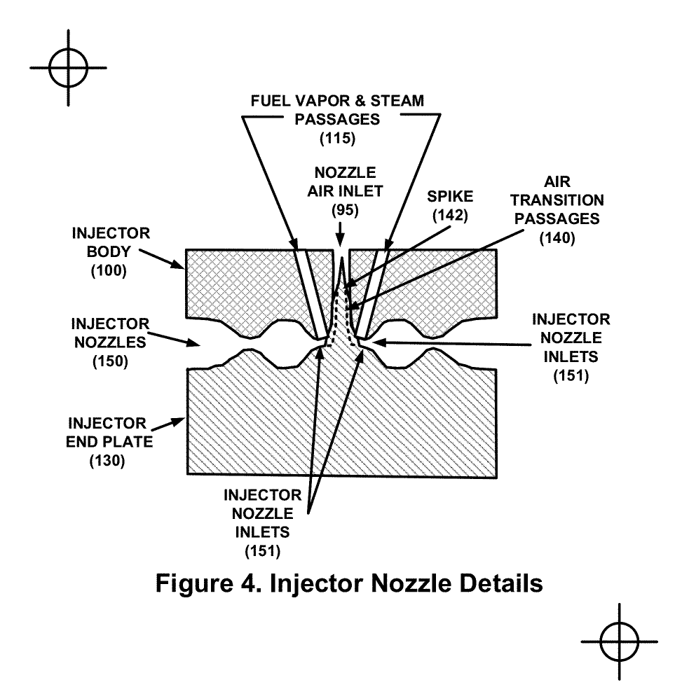

FIG. 4 is a cross-sectional view along the center axis of the Injector (60) (not shown) depicting details of the preferred embodiment. The shape depicted for the Injector Nozzles (150) is representative of nozzle design. Injector Nozzles (150) (indicated at left) are formed between the Injector End Plate (130) and the Injector Body (100). Fuel Vapor and Steam Passages (115) and the Nozzle Air Inlet (95) are drilled in the Injector Body (100). The diameter of the Fuel Vapor and Steam Passages (115) limits vaporization of the Superheated Water (80) (not shown) so that vaporization occurs mainly in the Injector Nozzle Inlets (151). Compressed Air (91) (not shown) is injected by the Air Mass Delivery System (49) (not shown) into the Nozzle Air Inlet (95). Compressed Air (91) (not shown), Fuel Vapor (74) (not shown), and Steam (83) (not shown) converge in the Injector Nozzle Inlets (151) where they ignite due to temperature of the Compressed Air (91). The Injector Nozzles (150) expands and accelerates the gases into the Engine Combustion Chamber (12) (not shown) at High velocities. Turbulence absorbs energy and reduces velocity. Turbulence is reduced by making smooth transitions in passages for Compressed Air (91) (not shown) and in the Fuel Vapor and Steam Passages (115). A Spike (142) is shown protruding from the Injector End Plate (130) into the Nozzle Air Inlet (95) which creates a tapered transition into the Air Transition Passages (140). The Air Transition Passages (140) (shown as dashed lines) are formed on the walls of the Spike (142) and make a smooth transition as they split into the Injector Nozzles (150). There is a close fit between the Injector Body (100) and the Spike (142). The Injector Body (100) forms one side of the Air Transition Passages (140).

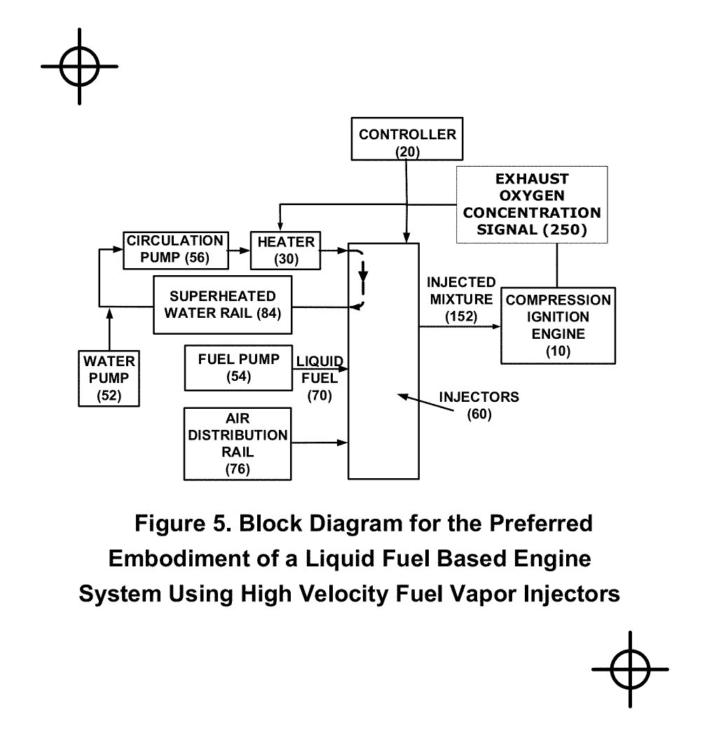

FIG. 5 depicts a Block Diagram for the Preferred Embodiment of a Compression Ignition Engine System Using a High Velocity Fuel Vapor Injector. A Controller (20) controls the Injectors (60) using several operating modes for power and efficiency. The Controller (20) also regulates the temperatures of the Heater (30), of the Superheated Water Rail (84), and of the Air Distribution Rail (76) (not shown), and receives the Exhaust Oxygen Concentration Signal (250) from the Compression Ignition Engine (10). Both the Superheated Water Rail (84) and the Air Distribution Rail (76) are insulated and heated to maintain uniform temperatures. The Heater (30) is heated by the combination of exhaust gases from the Compression Ignition Engine (10) and Liquid Fuel (70). The Controller (20) controls Liquid Fuel (70) that is sprayed into the combustion chamber of the Heater (30) and ignited. A Water Pump (52) supplies water at pressure necessary to prevent Superheated Water (80) (not shown) from vaporizing. A Circulation Pump (56) circulates Superheated Water (80) (not shown) through a Heater (30), the Superheated Water Rail (84) and the Injectors (60). A Fuel Pump (54) delivers Liquid Fuel (70) to the Injectors (60). Compressed Air (91) is delivered into the Injectors (60) from an Air Distribution Rail (76). A mixture of Fuel Vapor (74) (not shown), Steam (83) and Compressed Air (91) mix and ignite Injector Nozzle Inlets (151) (not shown) due to temperature of the Compressed Air (91). Injector Nozzles (150) (not shown) expand and accelerate the Injected Mixture (152) into the Engine Combustion Chamber (12) (not shown). Part of the Fuel Vapor (74) (not shown) burns in the Injectors (60). Most of the Fuel Vapor (74) (not shown) burns in the Engine Combustion Chamber (12) (not shown).

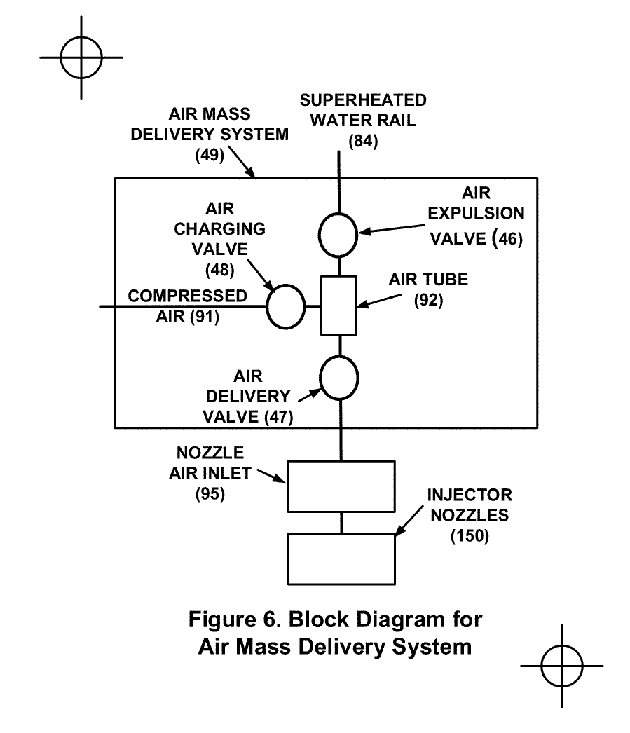

FIG. 6 depicts a Block Diagram of the preferred embodiment of an Air Mass Delivery System (49) which is part of the Injector (60) (not shown). The Air Mass Delivery System (49) makes the required level of fuel combustion in the Injector (60) (not shown) feasible. Compressed Air (91) (left center) enters the Air Tube (92) through the Air Charging Valve (48) which closes when the charge is complete. When air is required, the Air Expulsion Valve (46) admits Superheated Water (80) (not shown) into the Air Tube (92). The pressure and vaporization of Superheated Water (80) (not shown) drive Compressed Air (91) through the open Air Delivery Valve (47) through the Air Transition Passages (140) into the Injector Nozzles (150).

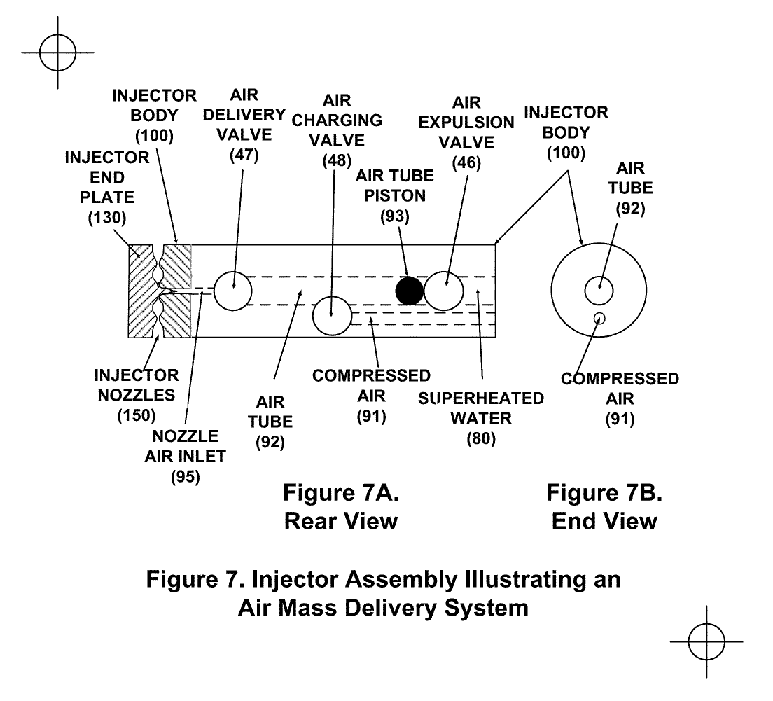

FIG. 7A and FIG. 7B depict the preferred embodiment for an Injector Assembly Illustrating an Air Mass Delivery System. Air is compressed to reduce its volume. Then the Air Mass Delivery System (49) (everything shown) provides a means to quickly deliver the reduced air volume required. Referring to FIG. 7A and starting at the top left and going counter clockwise, the end of the Injector Body (100) is sectioned and cross-hatched as is all of the Injector End Plate (130). The Injector Nozzles (150) are formed between the Injector Body (100) and the Injector End Plate (130). The Nozzle Air Inlet (95) (dashed lines) is a hole formed in the Injector Body (100) to admit Compressed Air (91) into the Injector Nozzles (150). The Air Tube (92) is a larger hole (center dashed lines) drilled the length of the Injector Body (100). Another hole (bottom right—dashed lines) is drilled for Compressed Air (91). An Air Charging Valve (48) fills the Air Tube (92) and closes. When Compressed Air (91) is required, the Air Expulsion Valve (46) admits Superheated Water (80) into the Air Tube (92). The Air Tube Piston (93) is driven into the Air Tube (92) and Compressed Air (91) is forced through the open Air Delivery Valve (47) into the Nozzle Air Inlet (95) of the Injector Nozzles (150). FIG. 7B at the right is an end view and depicts the Air Tube (92) drilled down the center of the Injector Body (100). A hole is also indicated for Compressed Air (91). When the Air Tube Piston (93) reaches the Air Delivery Valve (47), grooves (not shown) in the Air Tube (92) bypass the Air Tube Piston (93) which allows Superheated Water (80) as Steam (83) (not shown) to vent into the Nozzle Air Inlet (95) and into the Nozzles (150). Vented Steam (83) (not shown) cools the Injector Nozzles (150).

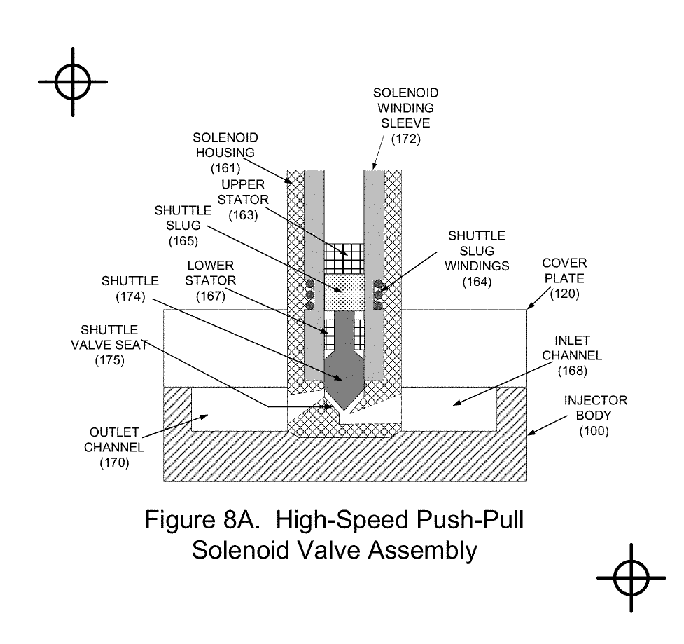

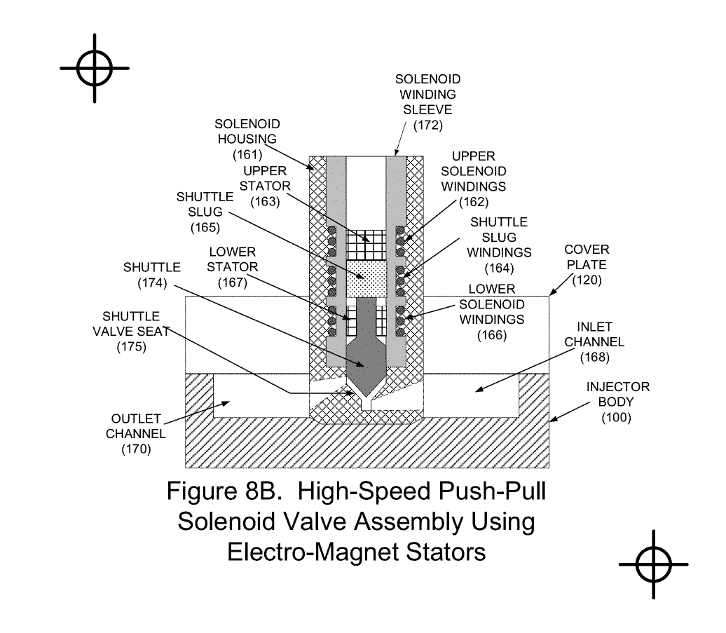

FIG. 8A depicts the preferred embodiment of a High-Speed Push-Pull Solenoid Valve Assembly Using Permanent Magnet Stators. Variations of the High-Speed Push-Pull Solenoid Valve Assembly are used for all of the valves used in the Injectors (60) (not shown). The Cover Plate (120) (middle right side), the Inlet Channel (168) and Injector Body (100) are parts of the Injector Assembly (64) (not shown). The Outlet Channel (170) is shown on the bottom left side. The Shuttle Valve Seat (175) and the Shuttle (174) are labeled at the left. In the position shown, the Shuttle (174) is lifted from the Shuttle Valve Seat (175) which opens a path between the Inlet Channel (168) and the Outlet Channel (170). The Upper Stator (163) and the Lower Stator (167) are permanent magnets whose magnetic fields are opposed: like poles face each other. The Shuttle Slug (165) is attached to the Shuttle (174) and moves between the Upper Stator (163) and the Lower Stator (167). Shuttle Slug Windings (164) induce magnetic fields in the Shuttle Slug (165). In the position shown, the Shuttle Slug (165) is attracted to the Upper Stator (163) and repelled by the Lower Stator (167). The magnetic forces are higher in the small gap between the Shuttle Slug (165) and the Upper Stator (163). When currents reverse in the Shuttle Slug Windings (164), the Shuttle Slug (165) is repelled by the strong force field of the Upper Stator (163). The Shuttle Slug (165) is attracted by the Lower Stator (167) with increasing force as that gap closes. The total force of repulsion and attraction is relatively constant as the Shuttle (174) moves between positions. When switching from closed to open, the Lower Stator (167) repels and the Upper Stator (163) attracts. In order to assure that the Shuttle (174) always closes against the Shuttle Valve Seat (175), the gap between the Shuttle Slug (165) and the Lower Stator (167) does not fully close in the off position. The parts described above fit into the Solenoid Housing (161) which installs in the Injector Assembly (64) (not shown but indicated by the Cover Plate (120) and the Injector Body (100)).

FIG. 8B depicts an alternate embodiment of a High-Speed Push-Pull Solenoid Valve Assembly Stators Using Electro-Magnet. This embodiment replaces permanent magnets with electro-magnets for the Upper Stator (163) and Lower Stator (167) and adds Upper Solenoid Windings (162) and Lower Solenoid Windings (166). The Upper Solenoid Windings (162) induce magnetic fields in the Upper Stator (163. Lower Solenoid Windings (166) induce magnetic fields in the Lower Stator (167). All other features are the same as the preferred embodiment described above.

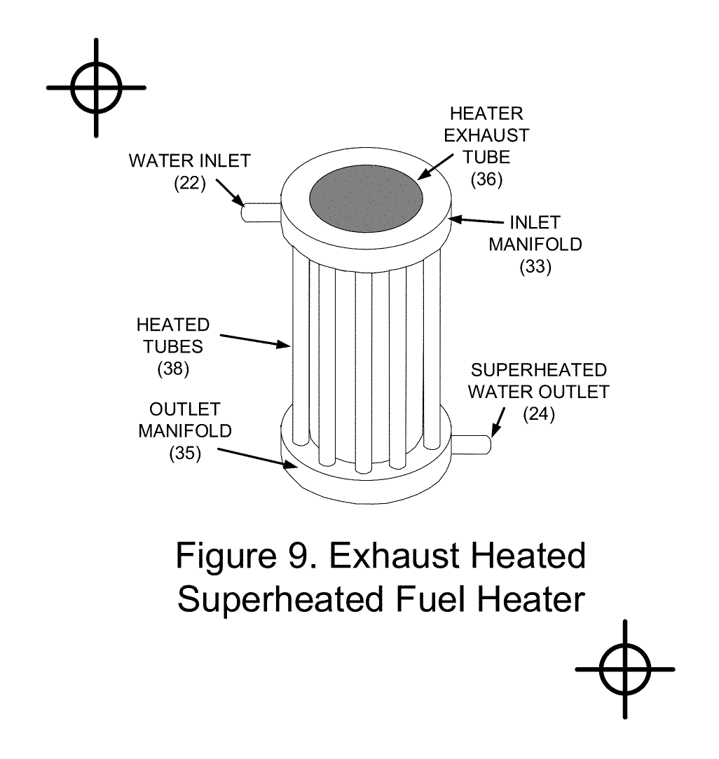

FIG. 9 depicts the preferred embodiment of an Exhaust Heated Superheated Water Heater (30). Exhaust gases from the Compression Ignition Engine (10) (not shown) pass through the Heater Exhaust Tube (36) indicated at top right. The surface area of the Heater Exhaust Tube (36) satisfies the heat transfer requirements of the Heater (30). The Water Inlet (32) feeds into an Inlet Manifold (33) that connects to Heated Tubes (38) which are brazed to the Heater Exhaust Tube (36). An Outlet Manifold (35) connects the Heated Tubes (38) to the Superheated Water Outlet (34). At startup and to supplement exhaust heating, the space around the Heated Tubes (38) is a combustion chamber. The external cover for the combustion chamber, liquid fuel spray, and igniter are not shown.

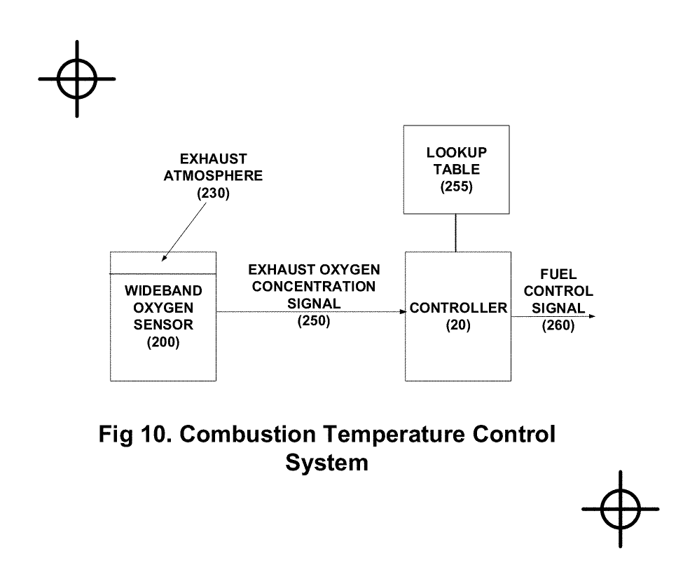

FIG. 10 depicts the preferred embodiment of a Combustion Temperature Control System (265) which has multiple operating modes. A Wideband Oxygen Sensor (200) senses the free-oxygen concentration in the Exhaust Atmosphere (230) and outputs an Exhaust Oxygen Concentration Signal (250) to the Controller (20). High levels of the Exhaust Oxygen Concentration Signal (250) indicate higher Air-to-Fuel Ratio and lower combustion temperature. The Controller (20) then adjusts the Fuel Control Signals (260) according to the current operating mode. In the high power mode, the Combustion Temperature Control System (265) adjusts the Fuel Control Signal (260) to maintain the Exhaust Oxygen Concentration Signal (250) between zero and just a little free-oxygen. This mode generates maximum power without injecting fuel that is not fully oxidized. In another mode, the engine operator selects an operating condition such as road speed. The Combustion Temperature Control System (265) then causes the free-oxygen concentration level to be as high as possible while maintaining the selected operating condition. In yet another mode, a display from the Combustion Temperature Control System (265) enables an operator to adjust engine operation to improve fuel efficiency while meeting other objectives. A Lookup Table (255) holds the characteristics of the combustion process. Using the Lookup Table (255) or other means, the Controller (20) adjusts the sequences and duration of injections to control heat release rate and consequent pressure rise rate. The Lookup Table (255) is also the basis for injection of Superheated Water (80) and steam to prepare the injection path for Fuel Vapor (74). The Lookup Table (255) is also the basis for Superheated Water (80) and steam injection following Fuel Vapor (74) injection to enhance post injection mixing.

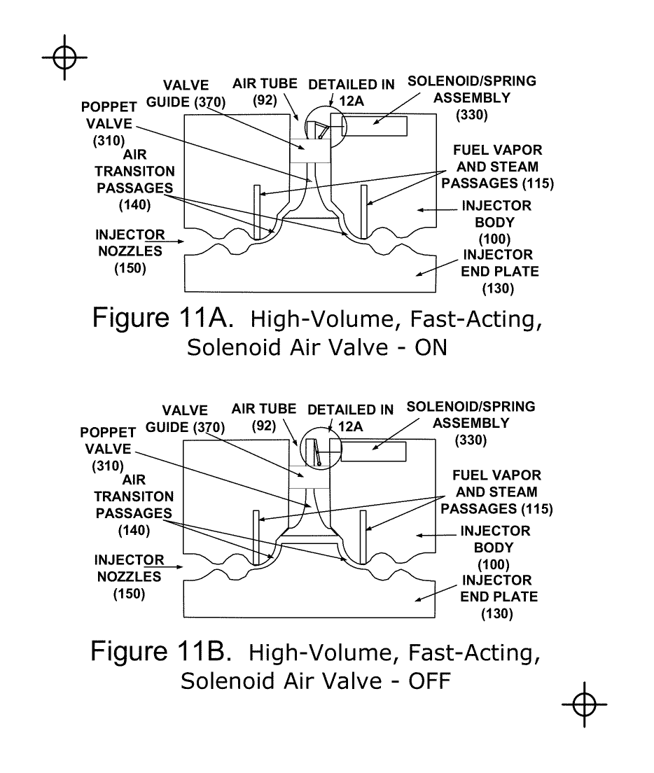

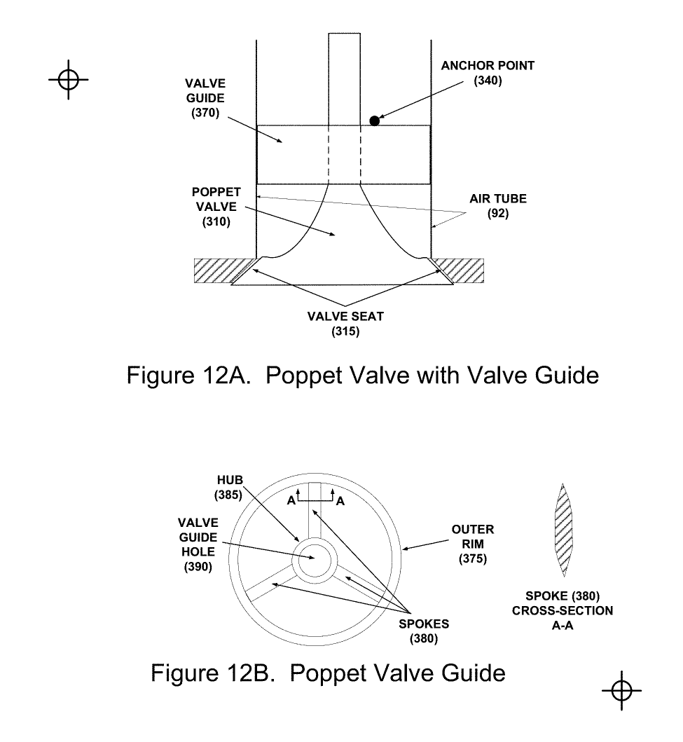

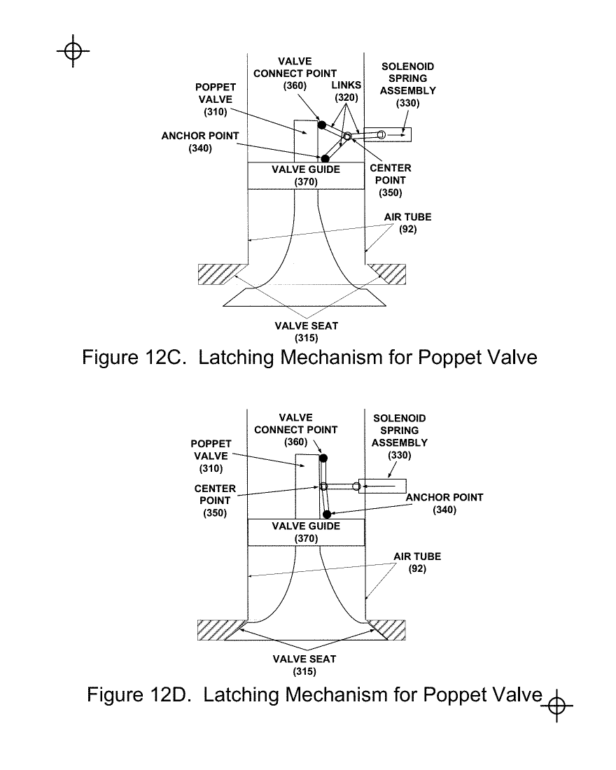

FIG. 11A is a cross-sectional view through the axis of a cylinder. FIG. 11A depicts the preferred embodiment of the Latching, High-Volume, Fast-Acting Solenoid Air Valve Assembly in its on-state. The Poppet Valve (310) is shown in the open position. Compressed Air (91) (not shown) flows from the Air Tube (92) over the edge of the open Poppet Valve (310) through the Air Transition Passages (140) and into the Nozzles (150). The Solenoid Spring Assembly (330) actuates the Poppet Valve (310) as detailed in FIGS. 12C and 12D. The Fuel Vapor and Steam Passages (115) feed Fuel Vapor (74) (not shown) and Steam (83) (not shown) which mix into the Compressed Air (91) (not shown). The mixture ignites in the Nozzles (150). The Nozzles (150) are formed between the Injector Body (100) and the Injector End Plate (130). In FIG. 11B, the Poppet Valve (310) is closed against the Valve Seat (315) (not indicated) in its closed position.

FIG. 12A depicts the Poppet Valve (310) inserted through the Valve Guide (370) with an Anchor Point (340) on the Valve Guide (370). FIG. 12B depicts the Valve Guide (370). The Valve Guide (370) has an Outer Rim (375) with Spokes (380) connecting to the Inner Hub (385). The stem of the Poppet Valve (310) slides through the Valve Guide Hole (390) in the Inner Hub (385) of the Valve Guide (370). As illustrated at right, the Spokes (380) are tapered on their leading and trailing edges to minimize resistance to airflow.

FIGS. 12C and 12D depict a Poppet Valve (310) within an Air Tube (92) with a latching mechanism to hold the valve closed. The views are cross-sections through the axis of a cylindrical structure. The Poppet Valve (310) is shaped like a flat headed nail with the head of the nail down. The stem of the Poppet Valve (310) is positioned on the axis of the Air Tube (92). The Valve Seat is indicated at the bottom. FIG. 12C depicts a gap between Poppet Valve (310) and the Valve Seat (315) which is the open position. There are three Links (320) which are pinned together at the Center Point (350). The free end of one Link (320) is secured to a Valve Connect Point (360) on the stem of the Poppet Valve (310). The free end of one Link (320) is secured to an Anchor Point (340) on the Valve Guide (370) which attaches to the walls of the Air Tube (92). The free end of one Link (320) attaches to a thrusting shaft in the Solenoid Spring Assembly (330). FIG. 12C depicts an open valve. The Center Point (350) has been pulled outward by the Solenoid Spring Assembly (330) pulling the valve stem downward and opening the Poppet Valve (310). FIG. 12D depicts a closed valve. The Center Point (350) is positioned slightly beyond a straight line between the Valve Connect Point (360) and the Anchor Point (340) which thereby latches the Poppet Valve (310) closed. The Center Point (350) is stopped by the stem of the Poppet Valve (310). In this position, the two links are in compression and prevent opening of the Poppet Valve (310). An Air Charging Valve (48) (not shown) fills the Air Tube (92) with Compressed Air (91) (not shown). When Compressed Air (91) is needed, the Solenoid Spring Assembly (330) pulls the Center Point (350) from the latched position. The Poppet Valve (310) moves toward the position depicted in FIG. 12C. The Air Expulsion Valve (46) (not shown) opens and Superheated Water (80) (not shown) enters the Air Tube (92) and forces Compressed Air (91) (not shown) against the Poppet Valve (310) helping it to open faster. The Solenoid Spring Assembly (330) holds the Poppet Valve (310) open to minimize back pressure. When the pressures of Air (75) (not shown) and Steam (83) subside in the Air Tube (92), the Solenoid Spring Assembly (330) returns the Poppet Valve (310) to its latched, off position.

Embodiments of the invention, which are intended in all respects to be illustrative rather than restrictive, have been described. Alternative embodiments will become apparent to those of ordinary skill in the art without departing from its scope. From the foregoing, it will be seen that embodiments of the invention one well-adapted to attain all the ends and objects set forth above, together with other advantages which are obvious and inherent to the system and method. It will be understood that certain features and sub-combinations are of utility and may be employed without reference to other features and sub-combinations. This is contemplated by and is within the scope of the claims.

What is claimed is:

1. A high velocity fuel vapor injector comprising:
liquid fuel;
superheated water;
compressed air;
an air tube;
and nozzles.

2. The high velocity fuel vapor injector of claim 1 wherein a mixture of said liquid fuel and said superheated water vaporizes.

3. The high velocity fuel vapor injector of claim 1 wherein a mixture of steam, of fuel vapor and of said compressed air ignites within said injector nozzles.

4. The high velocity fuel vapor injector of claim 1 wherein said injector nozzles expand and accelerate mixture of gases into the combustion chamber of said engine.

5. The high velocity fuel vapor injector of claim 1 wherein said superheated water expels air mass from said air tube into said injector nozzles.

6. The high velocity fuel vapor injector assembly comprising:
liquid channels;
air passages;
an injector body;
and valve assemblies.

7. The high velocity fuel vapor injector assembly of claim 6 wherein said liquid channels are formed in a plane on said injector body.

8. The high velocity fuel vapor injector assembly of claim 6 wherein said air passages are bored within said injector body.

9. The high velocity fuel vapor injector assembly of claim 6 wherein said valve assemblies are inserted into said liquid channels.

10. The high velocity fuel vapor injector assembly of claim 6 wherein said valve assemblies are inserted into said air passages.

11. A high switching speed electrical solenoid circuit comprising:
a shuttle;
at least two stators;
and solenoid windings.

12. The high switching speed electrical solenoid circuit of claim 11 wherein said stators are permanent magnets.

13. The high switching speed electrical solenoid circuit of claim 11 wherein like magnetic polarities of adjacent said stators face one another.

14. The high switching speed electrical solenoid circuit of claim 11 wherein there is contact between a face of said shuttle and a face of one said stator in either shuttle position.

15. The high switching speed electrical solenoid circuit of claim 11 wherein said solenoid windings produce magnetic fields in said shuttle.

16. The high switching speed electrical solenoid circuit of claim 11 wherein said solenoid windings produce magnetic fields in said stators.

17. A latching poppet valve assembly comprising:
a poppet valve;
a valve guide;
at least three links;
a common center pin;
a solenoid assembly;
compressed air;
and superheated water.

18. The poppet valve latching mechanism of claim 17 wherein said latching mechanism holds said poppet valve closed against pressures of said superheated water.

19. The poppet valve latching mechanism of claim 17 wherein said latching mechanism holds said poppet valve closed against pressures of said compressed air.

20. The poppet valve latching mechanism of claim 17 wherein each link is pierced by a freely rotating pin on each end.

21. The poppet valve latching mechanism of claim 17 wherein said at least three links hinge on said common center pin.

22. The poppet valve latching mechanism of claim 21 wherein one link also hinges on a pin on said valve guide.

23. The poppet valve latching mechanism of claim 21 wherein one link also hinges on a pin on said poppet valve.

24. The poppet valve latching mechanism of claim 21 wherein one link also hinges on a pin on the shuttle of said solenoid assembly.
